(19) United States
(12) Patent Application Publication
(10) Pub. No.: US 2015/0260826 A1
(43) Pub. Date: Sep. 17, 2015

(54) DETERMINING THE PRECISE GEOLOCATION OF A WIRELESS INTERNET TARGET

(71) Applicant: Worcester Polytechnic Institute, Worcester, MA (US)

(72) Inventor: Craig Shue, Worcester, MA (US)

(21) Appl. No.: 14/656,893

(22) Filed: Mar. 13, 2015

Related U.S. Application Data
(60) Provisional application No. 61/953,262, filed on Mar. 14, 2014.

(51) Int. Cl. G01S 5/02; G01S 5/06; H04W 4/02

(52) U.S. Cl. CPC G01S 5/0263; H04W 4/02; G01S 5/06; H04W 84/12

(57) ABSTRACT

The techniques herein describe an approach that can quickly geolocate Internet users that are connected through a wireless (e.g., WiFi) network. To do so, one or more embodiments herein send specially-crafted signals to the user's IP address. When these signals are broadcast by the user's wireless router to the user's wireless device, they have a discernible signature. Other geolocation efforts may then be used to scope the Internet user's location (e.g., to the appropriate city or section of a city). A user or automated device may then physically traverse (e.g., drive through) the search area listening on wireless channels for the discernible wireless signature. Once it is located, directional antennas and triangulation may be used to exactly locate the user.

### CROSS-REFERENCE TO RELATED APPLICATION

This application claims priority to and the benefit of U.S. Provisional Patent Application No. 61/953,262 filed in the United States Patent and Trademark Office on Mar. 14, 2014, the entire contents of which being incorporated herein by reference.

### TECHNICAL FIELD

The present invention relates generally to locating devices on a wireless network, and, more particularly, to determining the precise geolocation of a wireless internet target.

### BACKGROUND

It is relatively easy to determine an Internet user's rough location. Directed advertising often leverages the IP address of the user's machine and a geolocation database to tailor their marketing. Ongoing research has focused on increasing the precision of this geolocation, and recent work has shown the ability to geolocate IP addresses with a median error distance of 690 meters.

It is far more challenging to determine a user's exact street address given an IP address without information from the Internet Service Provider (ISP). For example, law enforcement often needs to be able to quickly geolocate an online suspect (e.g., to catch individuals distributing illegal content). The current approach of subpoenaing Internet Service Providers (ISPs) is too slow, often requiring days to learn the registered customer address of a suspect's IP address. By the time the ISP responds, the suspect may stop engaging in the illegal act and evidence may be destroyed/deleted. It is further difficult to determine the criminal from just an ISP customer address, since the home may be occupied by multiple individuals or guests. Law enforcement would like to have the geolocation results to a fine granularity in as close to real time as possible.

Without ISP subpoenas, even the best geolocation work to date is insufficient at narrowing down the suspect pool. As an example, considering a populated portion of the United States, with roughly 57,000 people per mi², a 690m radius circle could encompass around 33,000 people. There are often practical and judicial constraints on the number of suspects that can be investigated for a single crime.

### SUMMARY

The techniques herein describe an approach that can quickly geolocate Internet users that are connected through a wireless (e.g., WiFi) network. To do so, one or more embodiments herein send specially-crafted signals to the user's IP address. When these signals are broadcast by the user's wireless router to the user's wireless device, they have a discernible signature. Other geolocation efforts may then be used to scope the Internet user's location (e.g., to the appropriate city or section of a city). A user or automated device may then physically traverse (e.g., drive through) the search area listening on wireless channels for the discernible wireless signature. Once it is located, directional antennas and triangulation may be used to exactly locate the user.

### BRIEF DESCRIPTION OF THE DRAWINGS

The foregoing and other objects, features, aspects and advantages of the embodiments disclosed herein will become more apparent from the following detailed description when taken in conjunction with the following accompanying drawings.

FIG. 1 illustrates an example communication network and adversary techniques for precise geolocation of a wireless target.

FIGS. 2(a)-2(b) illustrate an example of precise geolocation of a wireless target in a residential neighborhood.

FIG. 3 illustrates an example of precise geolocation of a wireless target in an apartment building.

FIG. 4 illustrates an example of a computing device that may be used for precise geolocation of a wireless target.

FIG. 5 illustrates an example simplified procedure for precise geolocation of a wireless target.

### DETAILED DESCRIPTION OF THE EMBODIMENTS

The techniques herein address how quickly an IP address of a target can be converted into a real-word street address. Law enforcement regularly has a need to determine a suspect's exact location when investigating crimes on the Internet. They first use geolocation software and databases to determine the suspect's rough location. As noted above, recent research has been able to scope a targeted IP address to within a 690 m (0.43 mile) radius circle, which is enough to determine the relevant law enforcement department that has jurisdiction. Unfortunately, investigators face a “last half mile” problem: their only mechanism to determine the exact address of the suspect is to subpoena the suspect's Internet Service Provider, a process that can take days or even weeks. Instead, law enforcement would rather locate the suspect within the hour with the hope of catching the suspect while the crime is still on-going, which leads to stronger evidence and straightforward prosecution.

Given these time constraints, the embodiments herein provide a technique to allow an adversary to quickly locate a target without any special law enforcement powers. In particular, as described in greater detail below, the techniques herein leverage the use of ubiquitous wireless networks and a mobile physical observer that performs wireless monitoring (akin to “wardriving,” which seeks to search for wireless networks). The approach sends traffic from an adversary to the target's address that can be detected by the observer, notably even if wireless encryption is in use.

According to one or more embodiments herein, the techniques use wireless networking to aid geolocation. Users are increasingly adopting wireless networking technology with recent market research studies estimating between 61% to 80% of US homes use wireless networks. Accordingly, if an adversary can use the wireless network to identify a target, then the adversary may be able to simply physically traverse the search area looking for the target. This approach is similar to the “wardriving” concept of mapping networks, but rather than mapping all networks, the approach herein is looking for a particular one.

Notably, wireless networks often use encryption and consumer-grade wireless routers often use features (e.g., Network Address Translation (NAT)) that can prevent the delivery of unsolicited packets. Rather than simply sending an identifying message to the attacker and looking for that same message with a mobile wireless observer, the techniques herein provide mechanisms that overcome these obstacles.

The techniques herein combine covert Internet signals with wireless analysis in order to remotely identify a target's geophysical location. First, the search area is narrowed using conventional geophysical search techniques, and then a mobile observer device may be dispatched that physically traverses the search space while monitoring the wireless spectrum for signs of the wireless signature. Upon detecting the signature, the mobile adversary can detect the boundaries of the wireless signal and then use directional antennas to triangulate the target's wireless system's exact location.

This covert signaling process essentially forces the target's wireless LAN to issue beacons for pinpointing a target's location, similar to the namesake children's game of Marco Polo. This approach is viable since the search space can be exhaustively explored. These techniques are effective, even if the client uses wireless encryption and NAT devices.

As described in greater detail below, the techniques herein use covert wireless signals for geolocation, where an adversary seeks to locate a target using two components: a signaler and a mobile observer, where the signaler creates covert, flexible, and reliable signals for the observer to detect. The approach works beyond a laboratory environment, and is practical for use in real-world situations, such as a vehicle-based scan of a residential neighborhood, a walking scan of an apartment building exterior and interior, and so on. Furthermore, the techniques herein discuss countermeasures to preserve the target's privacy. These include not only well-known measures, such as using hardwired connections or proxy devices, but also more subtle countermeasures that could preserve the target's privacy without compromising convenience.

Defining the Adversary

The techniques herein enable an adversary to geophysically locate a machine using a targeted IP address. This adversary can be viewed as having two components: an Internet-based signaler and a physically mobile observer. While these components are separated in the description for clarity, they can be combined in practice without affecting the adversary's success. Thus, the adversary, as referred to herein, may represent the signaler and/or the mobile observer. This adversary has the following three abilities:
(a) the ability to communicate via the Internet;
(b) the ability to roughly geolocate a target's IP address; and
(c) the ability to physically scan the wireless spectrum of the geolocated physical region.

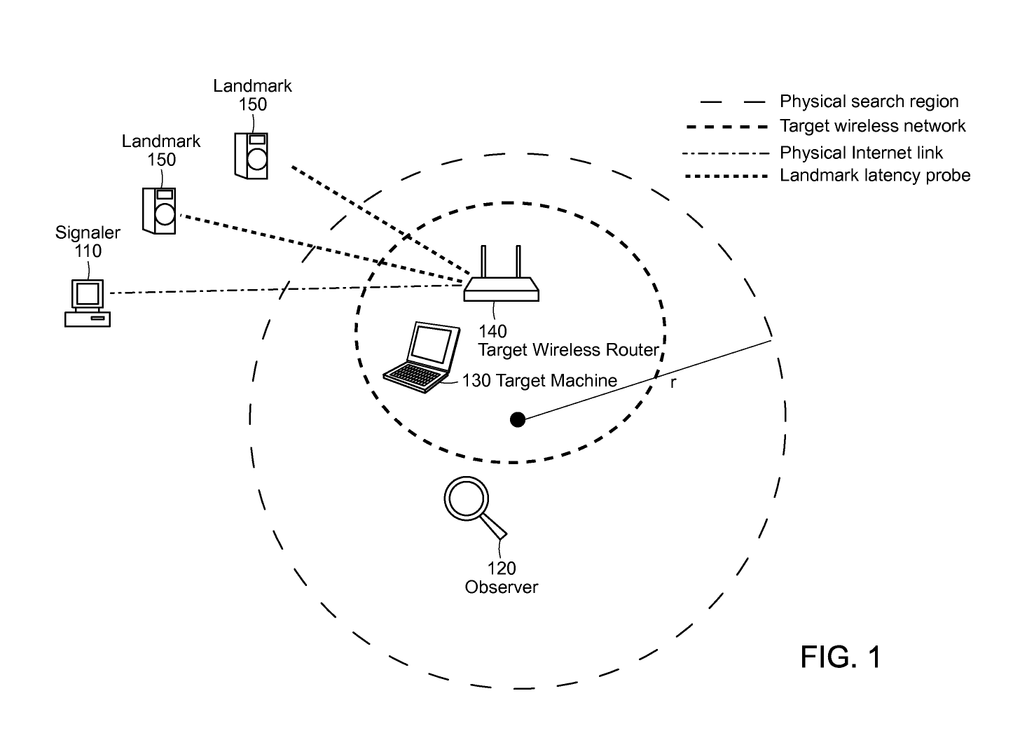

Referring now to FIG. 1, the adversary (e.g., signaler 110 and observer 120) illustratively follows a specific sequence of steps in an attack. First, the signaler 110 will remotely connect to a target 130 (for the purposes of the present disclosure, the target 130 may refer to a specific device(s) or an owner of said device(s)). Second, the signaler 110 will craft signal packets that create a unique signature in the wireless radio spectrum in the target's local area network that can be detected by the mobile observer 120. The signaler 110 and observer 120 can be different or the same device (e.g., and may be managed by different or the same user, respectively). Last, this mobile observer 120 can then use the covert embedded signal to locate the target 130.

The signaler 110 may first attempt to create an internet connection with the target 130. Regarding internet communication with the target 130, when a target is directly connected to the Internet through a wireless access point, communication with the target 130 becomes trivial. A wireless access point will wirelessly transmit any packet sent to the target's IP address. Even if the target 130 discards the traffic via firewalls or other mechanisms, the adversary will have succeeded in having the packet manifest in the wireless spectrum of the target network, which is sufficient to create a covert beacon signal. While this works well for wireless access points, the approach is more challenging when a wireless router (e.g., target wireless router 140) is involved.

In residential settings, users may configure the wireless router 140 to provide connectivity to multiple machines. To do so, the wireless router 140 employs network address translation (NAT). When an internal network user initiates a connection to a remote host, the NAT device creates a mapping associating the internal and remote network IP addresses and transport layer ports. When the remote host responds, the NAT device consults its mappings to send the packet to the correct internal host. However, if no mapping exists for an incoming packet, the NAT device cannot determine the appropriate internal host and instead drops the packet.

Since NAT will drop unsolicited network traffic from the adversary, the adversary must somehow lure the target 130 into initiating the connection with the adversary. In practice, the adversary has several options available. Adversaries may advertise servers with attractive content to lure the target 130 into establishing a connection, such as the FBI's use of honeypots advertising illicit content, as will be understood by those skilled in the art. Adversaries may also use peer-to-peer applications. Because NAT hinders peer-to-peer applications, these applications often have built-in NAT traversal techniques to allow peers to connect. Accordingly, when both the adversary and target run such software, the signaler 110 can either directly connect to the target 130 or advertise itself to the target 130, causing the target 130 to initiate the connection.

Once the signaler 110 is connected to the target 130, it can begin introducing the intended signal. That is, the signaler 110 may embed signals (via the connection) that are observable in the wireless network of the target 130. In doing so, it may need to keep the client connected to keep the NAT mappings valid. In other cases, the adversary may be able to keep the NAT mappings in place, even after the connection is closed. (The issues are discussed further below.)

Also, once a connection is made with the target, the signaler 110 must narrow the geophysical search space. To this end, a variety of work has focused on trying to roughly geolocate IP addresses, each providing varying degrees of proximity for geographical locations. Unfortunately, most of these approaches have error distances that are too large to exhaustively explore. However, there are certain techniques, such as “Towards street-level client-independent IP geolocation” (USENIX Symposium on Networked Systems Design and Implementation (NSDI), 2011) by Wang et al., that provide greater accuracy. For instance, the technique by Wang et al. provides street-level accuracy by leveraging the fact that businesses often run web servers locally and provide their local addresses publicly, and using these web servers as landmarks (e.g., landmark(s) 150) to estimate the geophysical location of a target IP address to within a median error of 690 meters in a best case (e.g., where nodes are publicly reported by universities). Larger median error rates were observed for residential (2.25 km) and online maps datasets (2.11 km). For instance, as shown in FIG. 1, the signaler 110 may establish a search region with a radius r using the available landmarks 150.

Notably, these landmark geolocation approaches improve with greater landmark density. Adversaries with more landmarks 150 would have better localization. In the case of law enforcement contexts, for example, officers (acting as an adversary locating a target) may volunteer to provide landmark services through their home ISP to aid in searches. These landmarks 150, in addition to public landmarks, may allow for more robust latency measurements to localize the geographic search region.

According to one or more embodiments herein, techniques may then be used to wirelessly scan a physical search region (e.g., the region defined by radius r, as shown in FIG. 1). That is, the approach described herein extends previous IP geolocation work by taking a rough location area and finding the exact location of the target IP address using active probing (e.g., by physically traversing the search region using observer 120 and searching for wireless LAN activity that matches the signal signature). In particular, under certain situations, with directional antennas and triangulation, one can identify the building or room in which a target is located along with its physical MAC address. Moreover, the observer 120 may coordinate with the signaler 110 so as to learn the embedded signal chosen by the signaler 110.

Illustratively, the techniques herein may wirelessly scan for a physical target 130 with specifically configured devices using off-the-shelf wireless components. For example, many modern wireless adapters allow programs to place the adapter into “monitor mode,” in which the wireless adapter senses all radio traffic on a given wireless channel. If placed near a wireless signal emitter, this monitoring device can record all transmitted packets. Wireless security protocols, such as WEP or WPA, simply encrypt packets starting with the network layer. Notably (and as utilized below), a monitoring device can still see the packet size and wireless MAC addresses of each communicated packet, regardless of encryption.

Digitally decoding multiple wireless signals in a reception range is a challenge. A typical commodity device can only tune to one wireless channel at a time. In North America, for example, the 802.11 B and G protocols require 11 channels to be monitored. However, to accommodate 802.11 A and N in the 5 GHz range, an additional 21 channels may need to be monitored. By creating a multi-channel listening device (e.g., by linking USB dongles through a USB hub to a laptop), it is possible to observe multiple (e.g., 11 or 32) channels simultaneously with excellent performance characteristics. An alternative approach, channel hopping, would also be viable. However, the speed at which the observer may search would be limited by the need to ensure each channel was observed long enough to detect the signal before continuing.

Note that while the detection of wireless signals through mobile detection units is a known concept, the techniques herein face specific challenges not previously presented, and the adversary's task herein differs from conventional arts in several ways. First, the mere presence of a wireless networking signal is not itself sufficient evidence: while any pirate signal or unapproved wireless signal is inherently evidence of unauthorized transmission, most wireless transmissions that the observer 120 will encounter will ultimately be irrelevant, greatly increasing the challenge. Rather than finding the source of any detected signal, the observer 120 must find the source of a particular signal among many.

Covert Communication Maintenance

The signaler 110 component must be able to reliably transmit signal packets for the observer 120 to find. The adversary's goal is to embed a covert beacon signal into the connection to the target 130. As explained above, when the target 130 is directly connected to a network via a wireless access point, such signaling is trivial. However, with NAT in wireless routers (e.g., target wireless router 140), the adversary must somehow keep a NAT mapping fresh while sending the signal. A couple options are straightforward: 1) use in-band signaling by providing the target with content or using keep-alive messages or 2) use connection-less protocols that cause NAT boxes to maintain a connection with a remote machine and simply send packets regularly enough to keep the connections fresh.

While both of these strategies are viable, the embodiments herein introduce two techniques that are broadly applicable for maintaining NAT state (and thus eliciting wireless transmissions) while not affecting any user applications running on the target machine 130.

A first technique is referred to as out-of-window TCP signaling. Time-to-live (TTL) fields in IP packet headers have been used to strategically drop packets after traversing network middleware. In the techniques herein, a mechanism may be used that drops a packet after it is transmitted wirelessly to the host, but before it reaches the user's application. Such a mechanism would allow application-agnostic signaling with less likelihood of detection.

The TCP protocol's sliding window implementation, which is designed to reorder and acknowledges packets, provides a suitable mechanism for strategic packet dropping. In particular, the targeted machine's TCP implementation will either silently discard or send duplicate acknowledgements to packets with out-of-window sequence numbers. Based on testing, MICROSOFT's WINDOWS XP, APPLE's MAC OS X, and REDHAT's LINUX operating systems each dropped out-of-order packets without impact to network applications, such as telnet or HTTP. In particular, these packets could only be detected using specifically configured packet capture software.

While out-of-window signal packets are discarded by multiple popular operating systems, it is important to note that such packets need also not be discarded by the target's router 140. By testing various consumer-grade wireless routers, it was shown that out-of-window packets were forwarded wirelessly by all of the tested routers. While some other routers may detect and discard out-of-order packets, out-of-band signaling is practical for several popular consumer routers.

A second technique is referred to as signaling after connection termination. Generally, all NAT devices must determine when to expire dynamic mapping. The Internet Engineering Task Force's (IETF's) Request for Comment (RFC) 2663 specifically warns implementers to not simply delete a mapping when a TCP “FIN” or “RST” packet is seen, since there could be retransmissions. Instead, it recommends deleting a mapping after 24 hours of non-use. RFC 5382 clarifies by recommending an idleness time-out no shorter than two hours. However, if either party sends a FIN packet, it states the mapping can be deleted only after four minutes of idleness. Certain commercial-grade NAT devices use a 24-hour expiration by default and renew a mapping whenever it is used, regardless of FIN packets or whether the entry renewal comes from inside the network or outside the network.

An adversary can exploit these standards and guidelines to allow indefinite covert signaling, provided it sends a signal at least once every four minutes. This would allow an adversary to temporarily establish a connection with the target 130 and then arbitrarily send signals as long as it desires, regardless of connection termination. Based on field testing (using raw sockets), the signaler 110 having sent packets even after a related TCP connection had terminated resulted in a reasonable percentage of consumer-grade routers continued to send packets to the destination after the connection is closed, while only a limited number did not, thus demonstrating that such signaling is indeed viable.

Signaling Using Variable Packet Lengths

Other geolocation covert signaling approaches are possible. For example, steganography, the study of secret messages inside of benign messages, may be used to create watermark signals to break privacy in locating the target 130. Illustratively, by varying packet lengths, the techniques herein can geophysically locate the target 130, as shown in FIG. 1. In particular, the 802.11 protocol transmits the packet length and the MAC addresses of the sender and destination in an unencrypted header for each packet, followed by the encrypted payload (if encryption is used). By sending the MAC addresses and length without encryption, wireless devices can quickly discard unrelated packets without cryptographic operations, conserving battery and computational resources.

The exposed packet length field and MAC addresses allow the observer 120 to easily detect the participants and packet sizes of wireless communication. If the signaler 110 sends specifically sized messages to the target 130, the observer 120 can detect whether these same sized packets are received by a wireless participant in its observable wireless spectrum area. By sending variously sized packets, the adversary can compute a confidence in how unlikely it would be for the pattern to occur in normal traffic, and the adversary could choose a pattern that should rarely occur in benign traffic.

It is understood in the art that many applications have specific packet sizes they favor (e.g., a single size or a limited number of specific file sizes for high percentages of traffic). Such consistent packet sizes for these applications can be easily distinguished from the irregular packet sizing technique presented by the techniques herein. Through experimentation (e.g., in a residential neighborhood), observed packet sizes were skewed to small packets and large packets, with packets ranging from 750 to 1500 bytes being relatively rare. Accordingly, in one embodiment herein, packets may be created with sizes selected uniformly at random from 750-1500 bytes to decrease the risk of unrelated activity producing signal values. This allows the techniques herein to tune detection to reduce false positives even when near busy wireless networks.

Packet size signaling has significant benefits. The detection of the signal is straightforward. The signaler 110 and observer 120 can use a shared database of packet lengths and synchronized clocks to detect packets that are signaled. Likewise, false positives are easy to detect since they tend to be isolated and are not part of a long sequence of signals. Furthermore, a longer correct sequence of events can improve an adversary's confidence of having detected the target 130.

Example Experiments Using Packet Size Signaling

Experiments were conducted to evaluate the packet size signaling approach to determine whether it is practical as a covert detection signal. The experiments used two real-world mobile observer tests to demonstrate the feasibility of the approach. The experiments used a laptop with an inexpensive external omni-directional wireless adapter for the mobile tests. As discussed above, experiments previously tested and confirmed the approach works using both enterprise-grade wireless access points and with consumer-grade wireless routers, in both 802.11g and 802.11n wireless networks in the 2.4 GHz and 5 GHz bands, with both WPA2 personal and WPA2 enterprise wireless security modes. In the mobile experiments, WPA2 personal and consumer-grade wireless routers were used; and the wireless networks were not joined, nor were there attempts to break the encryption of any transmissions.

The experiments configured the observer 120 to use Kismet v2011-03-R2, a wireless network packet capture tool, on the monitor system. The Kismet tool can be used to place the monitoring system's wireless adapter into “monitor mode,” in which the system sees each of the packets wirelessly transmitted. The system logs all the network activity it sees in the standard tcpdump packet capture format. By default, the Kismet tool uses channel hopping to continuously move across wireless channels. The experiments configured Kismet to focus on the specific wireless channel in use by the client to allow continuous monitoring of the client. This experiment is similar to using multiple adapters watching each channel of the spectrum in parallel and doing per-adapter analysis on each. Channel hopping schemes could also be used with a channel hop delay proportional to the signal delays.

To prepare for the experiments, a signal database was generated in advance. In this database, the experiments created two million records, each of which contained the signal value (the length of the packet to be sent) and the exact time that the signal would be transmitted. The experiments then copied this database to the observer and then disconnected the observer from all networks. To accommodate small differences in the system clock values at the signaler and the observer systems, the experiments provide a three second tolerance for comparing packets against the signal value. Accordingly, the observer 120 must check the length of each packet it detects to see if the packet length matches any of the possible valid signal values. If so, the observer 120 records the time, packet length, and source and destination MAC addresses from the packet header. For each destination MAC address, the techniques herein may determine the percentage of the last n transmitted signal packets that were actually sent wirelessly to the destination.

To show the practical applicability of the approach, two types of experiments were performed: 1) a single-blind driving geolocating test in a residential neighborhood, and 2) a walking test within and around a large apartment building. The experiments again used commodity hardware for the wireless infrastructure and laptop systems for the search device. The adversary was configured to monitor the same wireless channel as the target 130, emulating an adversary observing each wireless channel simultaneously.

A. Residential Neighborhood

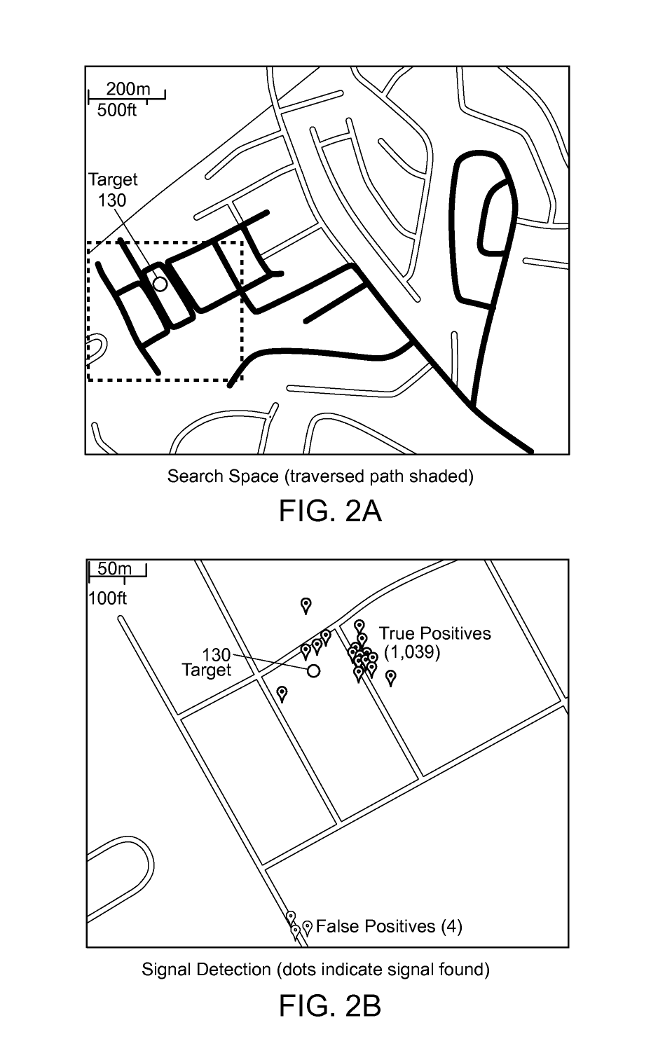

In the single-blind residential neighborhood experiment, the target device 130 used an existing wireless network in a residential neighborhood. The observer 120 attempted to find the target 130, and the observer 120 was blind to where the target 130 was located. The observer 120 was only told the wireless channel the target 130 would use (e.g., channel 11) and given a map of the rough area that the target 130 was in (e.g., the map segment shown in FIG. 2(a)). Further, the observer 120 knew the target 130 would use a wireless link to connect to the signaler 110 via the Internet. The rough location area map represents the approximate error-bounds of current geolocation techniques.

The target 130 used an existing wireless network in a residential neighborhood. To avoid biasing the experiment, the target 130 did not reposition the router 140 or laptop from their normal locations, despite clear obstacles that would hinder signal detection. The target's wireless router 140 linked the target's laptop 130 to a cable-based Internet connection. Through this wireless link, the target 130 connected to a remote server that acted as an adversarial machine. The target 130 left the connection active for the entire experiment.

To prepare for the experiment, the observer 120 copied the timestamp and packet size database file to a local laptop. The observer 120 then drove (e.g., in the case of the observer 120 involving a vehicle) to the search area and configured his vehicle for observations. The observer's equipment included 1) a car, 2) a laptop, 3) an external USB wireless adapter, which was taped to the car's passenger window, and 4) a GPS-enabled smartphone that recorded the vehicle movements with a clock synchronized with the observer's laptop. The observer 120 then drove around the search area. Each time a packet matched the signal, the laptop would emit an audible alert, allowing the observer 120 to focus on driving yet providing feedback to allow the observer 120 to circle back and perform follow-up measurements in potentially interesting areas. The observer was only allowed to monitor from public roads and sidewalks to emulate practical usage.

In FIG. 2(a), the search space is shown, using dark shading to show the path the observer took. The location of the target 130 is indicated for the reader's reference, though is not known in advance by the observer 120. In FIG. 2(b), an enlargement of the dashed region in FIG. 2(a), the locations where matches were found by the observer 120 are shown. The cluster near the bottom are false positives: the observer 120 saw four packets that matched the signal from two unique computers, but did not see any subsequent matches in the area. The observer 120 then continued searching and found a cluster of matches near the top. Each of these 1,039 matches were true positives. The volume and consistency of the matches allowed the observer 120 to have confidence that the observer 120 found the signal. The source and destination MAC addresses detected by the observer 120 were the correct MAC addresses for the target's router 140 and laptop 130.

Before revealing the location of the target 130 to the observer 120, the observer 120 was asked about the target's likely location. The observer 120 could not narrow it down to a specific house and instead indicated that a gap between two houses had the strongest reading. Through this gap, the rear portion of a third house was visible. The target 130 was actually located in the rear portion of this third house. Physical obstructions (a masonry fireplace with metallic shielding and a large LCD panel television) were directly next to the wireless router 140, likely obstructing the signal in other directions from the house, hindering readings that would have further aided localization. In performing this experiment, directional antennas or signal strength meters were not used, which may have allowed the adversary to determine the exact target location.

This experiment demonstrates the practicality of the approach. The observer 120 was given a search space of roughly 1.23 km², while previous work has localized an attacker to 1.50 km², causing the experiment's search area to be roughly 82% of realistic bounds. The experiment was able to localize the likely target location to roughly 0.01 km² (about 3 houses) with the techniques herein. The observer 120 traversed roughly half of the search space, driving at around 10 mph for 33 minutes before first finding a valid match. It then took the observer 120 four additional minutes to find a location with a strong signal (allowing him to see 100% of packets in a 40-packet sliding window). During the experiment, the signaler 110 sent about 9.6 MB of signal, averaging about 4.38 KB/s.

Importantly, during the experiment, the observer 120 was able to exclude significant unrelated wireless network activity. At the target area alone, there were over 15 visible wireless networks, of which four were transmitting on the same channel as the target 130. The observer 120 saw 24,030 packets on the monitored channel that did not match the signal and could be ignored. Further, our false positive rate was only 0.38%. Given that 1,039 packets were a true positive, the techniques herein can quickly eliminate these false positives in the search results. This experiment shows that an adversary can realistically examine a search space to localize the target 130. Multiple observers 120 could operate in parallel to expedite localization, such as in the case of law enforcement usage.

B. An Apartment Building

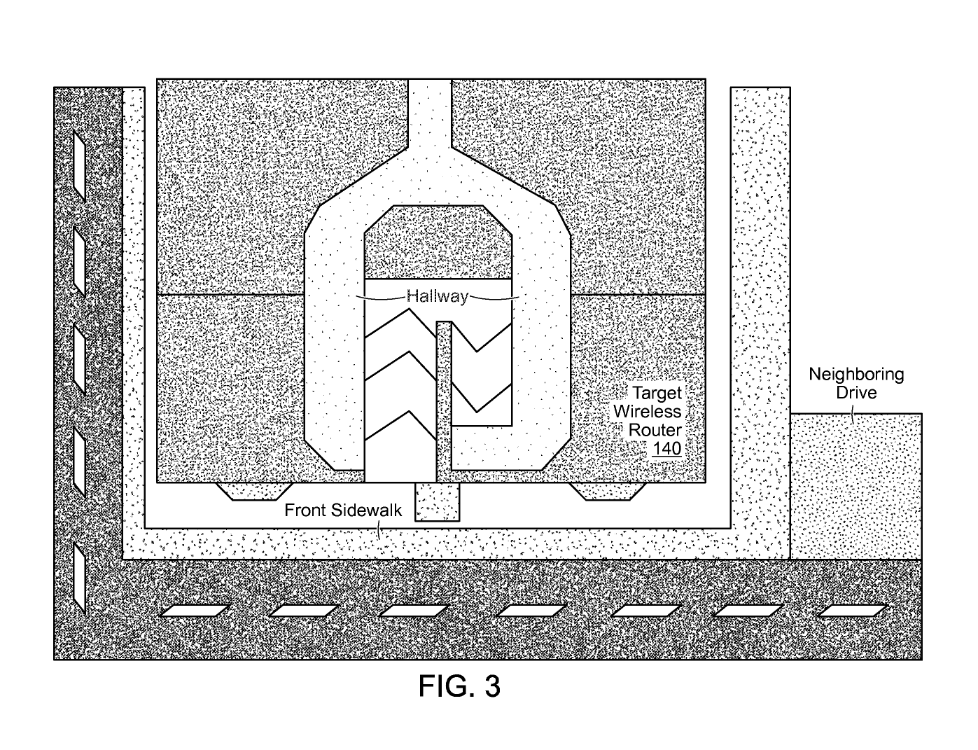

In this experiment, the target 130 was positioned on the second floor of a three-story apartment building, as shown in FIG. 3. The target 130 was connected to the signaler 110 via its wireless network. The observer 120 traversed the exterior of the building and interior hallways to determine the feasibility of an adversary trying to detect a target inside a multi-unit dwelling. All three levels of the apartment have the same design with four apartments per floor. The building has other similarly constructed buildings nearby and there were approximately fifteen different wireless networks visible from within the building.

The observer 120 was able to detect the target 130 from various locations outside the building, including the neighboring public street. From outside the building, the wireless network was best detected along the front sidewalk but was also discoverable from the neighboring drive and roadway in front of the building with approximately 50% of the TCP sliding window matching. The target 130 was also located by running tests in the halls of all three floors. The detection rate was strongest on each floor in the quadrant nearest to the router 140, with true positive detection rates around 100%. However, the detection rate did not uniformly change with distance in many cases. The detection rate fluctuated greatly throughout the halls and had worse performance in hallways on the distant portion of the building. This is likely due to the construction of the building and signal deflection due to walls and stairwells. Despite these issues, and a few areas where the signal could not be detected, the observer 120 was able to detect the target 130 in the majority of the building.

This experiment demonstrates that the packet length method works well, even in an apartment environment. The successful discovery of the target 130 from outside the building makes many use-cases feasible. Being able to see this type of apartment from a public roadway is a desired result because unauthorized entering of the building may not be possible in some cases.

Countermeasures

Notably, most Internet users are unlikely to employ countermeasures, due to lack of awareness of the risks or because they lack the necessary technical expertise. However, the techniques herein may also be configured to address countermeasures that could be employed by privacy-conscious individuals.

The most straightforward approach to prevent detection is to use either a wired network or a proxy machine. The wired network will thwart analysis of the techniques herein since it eliminates the wireless signal. A proxy creates another level of indirection and the true target IP address may only be known to this proxy. While both countermeasures would be possible, they may be inconvenient for the target 130. Instead, the techniques herein investigate countermeasures that could be integrated into current networking hardware transparently.

While modern wireless routers do not regularly fragment or resegment packets, the target 130 could change its wireless router 140 to enforce policies that alter all packet sizes. While enforcing constant-sized packets with padding is feasible, it could be detected easily. A router that uses variable-size packet reshaping would thwart the packet-length detection approach. However, it does not eliminate identification through more primitive approaches (such as sending data bursts resembling Morse-code). To protect against someone using data bursts while enforcing constant packet sizes, the target 130 can saturate its bandwidth to hide a possible signal, but at a significant performance cost.

Anomaly detectors could also be used by the target 130 to detect out-of-window packets and abnormal traffic shaping by its peers. Upon detecting an anomaly, the target 130 could request its wireless router 140 or access point (AP) to filter traffic from that source. However, an adversary with multiple machines may be able to continue the attack from a different source.

### CONCLUSION

The techniques described herein, therefore, provide for a precise geolocation of a wireless target. In particular, the techniques herein can convert an IP address into a physical location quickly (e.g., in less than an hour) without any special law enforcement powers or support from ISPs. Notably, unlike techniques that use traditional covert channels, which blend a signal into a legitimate communication, the techniques herein derive location via side-channel techniques rather than through data exfiltration. In addition, the techniques herein do not require subpoenas or other ISP cooperation, do not require man-in-the-middle abilities (and need only to establish a TCP connection with the target if the target uses NAT), do not assume the adversary is within wireless range of the target (first a location is narrowed, then the techniques precisely locate the target's location). Moreover, the techniques herein use variable sized packets to quickly and robustly confirm the target's signal, and can use multiple types of covert signals. As such, with these relaxed assumptions, the techniques herein are particularly practical for adversaries without a subpoena or other ISP cooperation.

Illustratively, the techniques described herein may be performed by hardware, software, and/or firmware, such as in accordance with one or more processes (e.g., on a single device or distributed across a plurality of devices) which may contain computer executable instructions executed by a processor to perform functions relating to the techniques described herein.

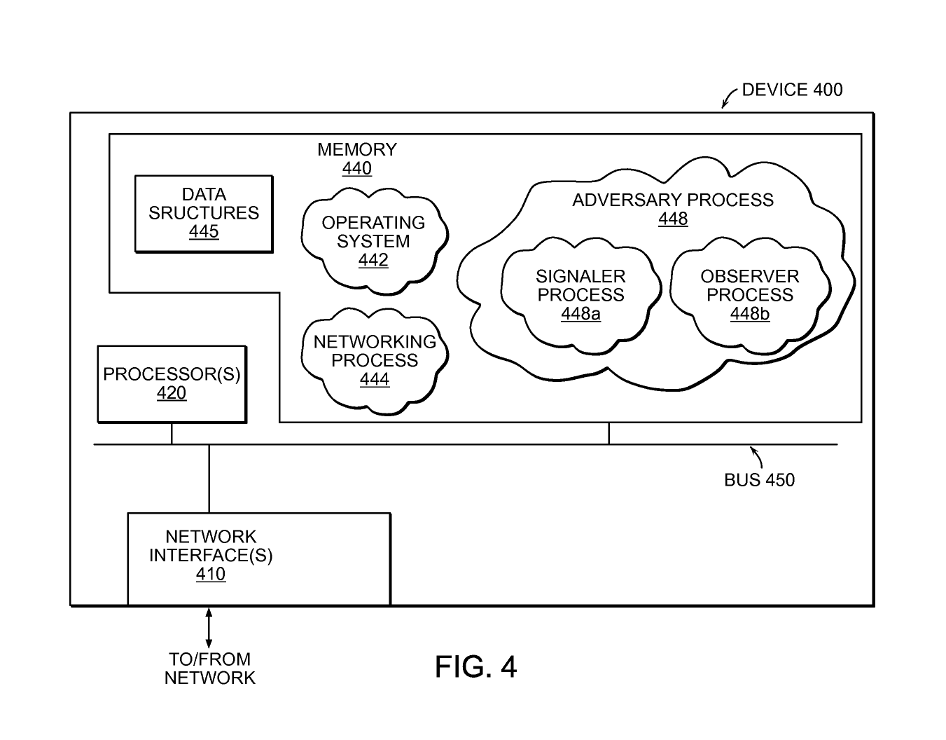

FIG. 4 is a schematic block diagram of an example device 400 that may be used with one or more embodiments described herein, e.g., as the signaler 110 and/or mobile observer 120, as mentioned above. Device 400, such as a personal computer, laptop, mobile computing device (e.g., tablet, smartphone, etc.) comprises at least one network interface 410, one or more processors 420, and a memory 440 interconnected by a system bus 450. The network interface(s) 410 contain(s) the mechanical, electrical, and signaling circuitry for communicating data over a communication network (e.g., wireless). The network interfaces may be configured to transmit and/or receive data using a variety of different communication protocols.

The memory 440 comprises a plurality of storage locations that are addressable by the processor(s) 420 and the network interface(s) 410 for storing software programs and data structures associated with the embodiments described herein. The processor 420 may comprise necessary elements or logic adapted to execute the software programs and manipulate the data structures 445. An operating system 442, portions of which are typically resident in memory 440 and executed by the processor(s), functionally organizes the node by, inter alia, invoking operations in support of software processes and/or services executing on the device. These software processes and/or services may comprise networking services 444 and an illustrative adversary process 448 (e.g., signaler process 448a and observer process 448b).

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

Networking process/services 444 contain computer executable instructions executed by processor 420 to perform functions provided by one or more networking protocols, such as the various known wireless communication protocols (e.g., IEEE 802.11), as will be understood by those skilled in the art. Adversary process 448 (e.g., signaler process 448a and observer process 448b) contains computer executable instructions executed by processor 420 (of a signaler and/or observer, respectively) to perform functions relating to the techniques described herein.

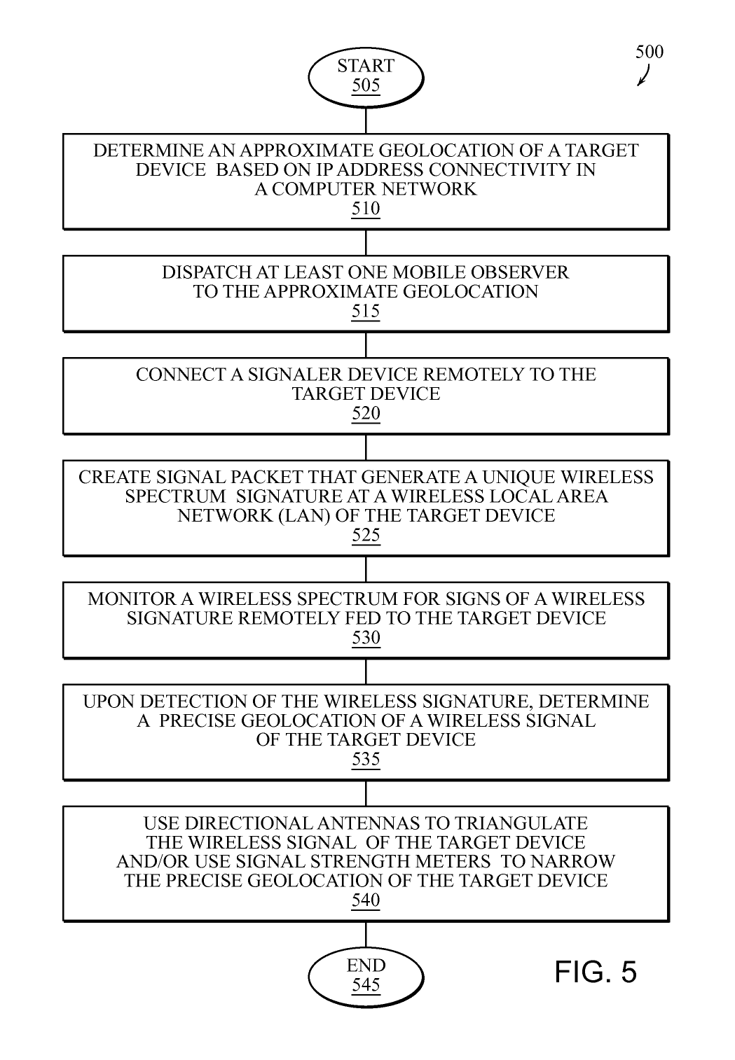

In addition, FIG. 5 illustrates an example simplified procedure 500 for precise geolocation of a wireless target in accordance with one or more embodiments described herein. The procedure 500 may start at step 505, and continues to step 510, where, as described in greater detail above, an approximate geolocation of a target device may be determined based on IP address connectivity in a computer network. For example, as mentioned above, the approximate geolocation may be illustratively detected based on landmarks 150 with a listed physical address being located within a same subnet of the IP address of the target device 130. In step 515, at least one mobile observer 120 may be dispatched to the approximate geolocation

In step 520, a signaler device 110 may connect remotely to the target device 130 (e.g., via a peer-to-peer application, and/or having lured the target device to connect to the signaler device). Note that the signaler device 110 may maintain a connection through select additional packets, such as keepalives, additional (and adequately timed) data, etc. Through this connection, the signaler device 110 may then proceed to create and transmit signal packets that generate a unique wireless spectrum signature at a wireless LAN of the target device 130 in step 525. In one embodiment, as described above, the signaler device 110 may use a TTL timer to drop packets after last-hop transmission to the target device 130, thereby not reaching the target device 130. In another embodiment, the signaler device 110 may use packet sequence numbers, checksums, or alterations to other packet header fields of packets that cause a network adapter or operating system of the target device 130 to drop the packets before being delivered to the target device 130 while still ensuring the packet is recognized as valid by Internet routing infrastructure to ensure delivery to the target device 130.

The mobile observer 120 (or a plurality of mobile observers 120) dispatched to the approximate geolocation of the target 130 may then monitor a wireless spectrum for signs of a wireless signature remotely supplied to the target device in step 530 (e.g., listening to all available wireless channels while monitoring the wireless spectrum). As described in greater detail above, the wireless signature may be created and detected using a number of techniques, such as by:
a) monitoring a packet length of each detected packet within wireless range of the mobile observer 120, and detecting signs of the wireless signature based on a packet length pattern matching that of the supplied wireless signature (e.g., accounting for adjusted packet length when matching the packet length pattern);
b) forcing a wireless LAN of the target device 130 to issue beacons, and detecting signs of the wireless signature based on receiving the issued beacons;
c) monitoring for a steganographic code within one or more detected packets within wireless range of the mobile observer 120, and detecting signs of the wireless signature based on detecting the steganographic code;
d) monitoring for Morse-code bursts from a series of detected packets within wireless range of the mobile observer 120, and detecting signs of the wireless signature based on detecting the Morse-code bursts;
e) and so on.

Upon detection of the wireless signature in step 535, such as a singular detection, or more likely, a plurality of detections to confirm a result (and eliminate any false positives), the precise geolocation of a wireless signal of the target device 130 may be correspondingly determined. Note that in step 540, directional antennas to triangulate the wireless signal of the target device 130 and/or signal strength meters to narrow the precise geolocation of the target device 130 may be used. Additionally, a version of the “multiple signal classification” (MUSIC) algorithm may be used to estimate the direction of arrival (DoA) of signals (Kundu, Debasis, “Modified MUSIC Algorithm for Estimating DOA of Signals,” Signal Processing, Vol. 48, No. 1, 85-90 (1996)), along with an array of omnidirectional antennas, in order to triangulate the wireless signal of the target device.

The simplified procedure 500 may then end in step 545. It should be noted that while certain steps within procedure 500 may be optional as described above, the steps shown in FIG. 5 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

While there have been shown and described illustrative embodiments that provide for precise geolocation of a wireless target, it is to be understood that various other adaptations and modifications may be made within the spirit and scope of the embodiments herein, with the attainment of some or all of their advantages. For instance, it is expressly contemplated that the components and/or elements described herein can be implemented as a system of components/devices, a single component/device, or a system of components/devices and human interaction (e.g., physically searching an area with the configured device). Moreover, it is expressly contemplated that the components and/or elements described herein can be implemented as software being stored on a tangible, non-transitory computer-readable medium (e.g., disks/CDs/RAM/EEPROM/etc.) having program instructions executable by a controller, as described above, which may constitute hardware, firmware, or a combination thereof. Accordingly this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method, comprising:
determining an approximate geolocation of a target device based on Internet Protocol (IP) address connectivity in a computer network;
dispatching at least one mobile observer to the approximate geolocation;
monitoring a wireless spectrum for signs of a wireless signature remotely supplied to the target device; and
upon detection of the wireless signature, determining a precise geolocation of a wireless signal of the target device.

2. The method as in claim 1, further comprising:
using directional antennas to triangulate the wireless signal of the target device.

3. The method as in claim 1, further comprising:
monitoring a packet length of each detected packet within wireless range of the mobile observer; and
detecting signs of the wireless signature based on a packet length pattern matching that of the supplied wireless signature.

4. The method as in claim 3, further comprising:
accounting for adjusted packet length when matching the packet length pattern.

5. The method as in claim 1, further comprising:
forcing a wireless local area network (LAN) of the target device to issue beacons; and
detecting signs of the wireless signature based on receiving the issued beacons.

6. The method as in claim 1, further comprising:
monitoring for a steganographic code within one or more detected packets within wireless range of the mobile observer; and
detecting signs of the wireless signature based on detecting the steganographic code.

7. The method as in claim 1, further comprising:
monitoring for Morse-code bursts from a series of detected packets within wireless range of the mobile observer; and
detecting signs of the wireless signature based on detecting the Morse-code bursts.

8. The method as in claim 1, further comprising:
connecting a signaler device remotely to the target device.

9. The method as in claim 8, further comprising:
connecting via a peer-to-peer application.

10. The method as in claim 8, further comprising:
luring the target device to connect to the signaler device.

11. The method as in claim 8, further comprising:
maintaining a connection through select additional packets.

12. The method as in claim 1, further comprising:
creating signal packets that generate a unique wireless spectrum signature at a wireless local area network (LAN) of the target device.

13. The method as in claim 1, further comprising:
using signal strength meters to narrow the precise geolocation of the target device.

14. The method as in claim 1, further comprising:
detecting the approximate geolocation based on landmarks with a listed physical address being located within a same subnet of the IP address of the target device.

15. The method as in claim 1, further comprising:
listening to all available wireless channels while monitoring the wireless spectrum.

16. The method as in claim 1, further comprising:
using packet sequence numbers, checksums, or alterations to other packet header fields of packets that cause a network adapter or operating system of the target device to drop the packets before being delivered to the target device while still ensuring the packet is recognized as valid by Internet routing infrastructure to ensure delivery to the target device.

17. The method as in claim 1, further comprising:
using a version of the “multiple signal classification” (MUSIC) algorithm, along with an array of omnidirectional antennas, to triangulate the wireless signal of the target device.

18. A system, comprising:
a signaler device configured to remotely supply a wireless signature to a target device; and
at least one mobile observer, the mobile observer configured to:
dispatch to an approximate geolocation of the target device based on Internet Protocol (IP) address connectivity in a computer network;
monitor a wireless spectrum for signs of the wireless signature remotely supplied to the target device; and
upon detection of the wireless signature, determine a precise geolocation of a wireless signal of the target device.

19. The system as in claim 18, wherein the signaler device is further configured to create the wireless signature and the mobile observer is configured to detect signs of the wireless signature based on the wireless signature being selected from a group consisting of: a packet length pattern to match that of the supplied wireless signature; forced beacons issued by a wireless local area network (LAN) of the target device; steganographic code within one or more packets; and Morse-code bursts created by a series of packets.

20. The system as in claim 18, wherein the signaler device and the mobile observer are collocated on a singular device.

21. A tangible, non-transitory computer-readable media having software instructions contained thereon, the software instructions, when executed by a process, configured to:
monitor, at an approximate geolocation of a target device determined based on Internet Protocol (IP) address connectivity in a computer network, a wireless spectrum for signs of a wireless signature remotely supplied to the target device; and
upon detection of the wireless signature, determine a precise geolocation of a wireless signal of the target device.
